(19) United States
(12) Patent Application Publication
(10) Pub. No.: US 2022/0300993 A1
(43) Pub. Date: Sep. 22, 2022

(54) SYSTEM AND METHOD FOR CONDUCTING A SURVEY BY A SURVEY BOT

(71) Applicant: Jio Platforms Limited, Ahmedabad (IN)

(72) Inventors: Arijay CHAUDHRY, Maharashtra (IN); Ravindra Singh CHHABRA, Madhya Pradesh (IN); Sachin DEV, Maharashtra (IN); Abhishek FARKADE, Maharashtra (IN); Gaurav DUGGAL, Telangana (IN)

(73) Assignee: Jio Platforms Limited, Ahmedabad (IN)

(21) Appl. No.: 17/698,202

(22) Filed: Mar. 18, 2022

(30) Foreign Application Priority Data
Mar. 18, 2021 (IN) 202121011485

(51) Int. Cl. G06Q 30/02; H04L 51/02; G06N 20/00

(52) U.S. Cl. CPC G06Q 30/0203; H04L 51/02; G06N 20/00

(57) ABSTRACT

The present disclosure provides a system and method for generating automatic video frame responses without getting help from an expert/professional assistance as well as ability to customize responses for a set of survey queries. The system includes a processor that executes a set of executable instructions stored in a memory, upon execution of which, the processor causes the system to receive video frame responses that are mapped to each survey query of the set of survey queries. The set of survey queries may be any or a combination of open ended, ratings related, satisfaction related, choice related queries but not limited to these. The system may be configured to link the set of queries to the video frame responses that have been recorded and also facilitate the user to initiate the survey at his/her convenience and resume the survey if there may be a break in the survey.

### FIELD OF INVENTION

The embodiments of the present disclosure generally relate to facilitating a survey. More particularly, the present disclosure relates to a system and method for facilitating a survey with one or more automated video frame responses to a user query based on a machine learning based architecture.

### BACKGROUND OF THE INVENTION

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

A survey is generally a research method used for collecting data from a predefined group of respondents to gain information and insights into various topics of interest. Surveys may be conducted by phone, mail, via the internet, and sometimes face-to-face on busy street corners or in malls. Surveys can be specific and limited such as interviews for a particular entity, or they can have more global, widespread goals. For example, Psychologists and sociologists often use surveys to analyze behaviour. More often, surveys are used to meet the more pragmatic needs of the media, such as, in evaluating political candidates, public health officials, professional organizations, and advertising and marketing directors. Survey is also done in the medical and surgical fields to gather information about healthcare personnel's practice patterns and professional attitudes toward various clinical problems and diseases and how well they are suited for a particular role.

A survey consists of a predetermined set of questions that is given to a sample. With a representative sample, that is, one that is representative of the larger population of interest, one can describe the attitudes of the population from which the sample was drawn. Further, one can compare the attitudes of different populations as well as look for changes in attitudes over time. A good sample selection is key as it allows one to generalize the findings from the sample to the population, which is the whole purpose of survey research.

Currently, surveys require seasoned experts to ask questions intelligently to respondents. This also brings in bias from the person posing questions. Many entities rely on electronic mail (email), telephone, etc., to conduct survey. However, email communication systems are more than two decades old, not secure, typically laced with spam, a primary deliverer of viruses, cluttered, are error prone, and are a cause for disconnects between the user taking the survey and the entity conducting the survey. Anyone who has tried to obtain customer support using a telephone system will appreciate that call centres do not improve the situation. A user taking the survey must listen to numerous recorded messages, navigate through countless menus, and start all over if there is a single incorrect number entered. Moreover, the user, once lucky enough to reach a live operator is often transferred, often more than once, each time providing countless security credentials in order to provide some modicum of security to the call. Phone based communication can be ambiguous due to noise and absence of clarity in use of words, phrases and the like. Also, current surveys require training of a large number of people for asking questions to users taking the survey. Moreover, responses are not accurately captured due to presence of human flaws and hence there is a high chance of occurrence of mistakes. Furthermore, there is always the possibility of human bias from the interview process especially where likeability, satisfaction or rating scales are involved.

Hence, there is a long felt but unresolved need in the art for replacing conventional email and call in systems to conduct surveys and facilitate a secure bidirectional video based communication and transactions with users for conducting surveys in real time.

### OBJECTS OF THE PRESENT DISCLOSURE

Some of the objects of the present disclosure, which at least one embodiment herein satisfies are as listed herein below.

It is an object of the present disclosure to enable an entity-specific bot for conducting surveys.

It is an object of the present disclosure to provide for a system to facilitate a more personal front to surveys and replace phone based surveys with video based ones.

It is an object of the present disclosure to provide a system and a method for enabling removing the need to train a large number of people for asking questions to respondents.

It is an object of the present disclosure to provide a system and a method for enabling an entity to implement as well as customize visual responses that are generated to an user query based on their requirements, without the need to hire an expert/professional assistance.

It is an object of the present disclosure to provide a system and a method that can provide a platform to an user for getting, from an entity-specific bot, automated visual/video frame responses to a query regarding one or more operational services provided by an entity.

It is an object of the present disclosure to provide a system and a method to facilitate quick and accurate capture of user responses by the survey bot thereby minimizing mistakes.

It is an object of the present disclosure to provide an approach for removing human bias from an interview process especially where likeability, satisfaction or rating scales are involved.

It is an object of the present disclosure to provide a system and a method for ensuring that users taking the survey are able to complete the survey at a time convenient to them and terminate the survey at their discretion.

It is an object of the present disclosure to provide a system and a method to facilitate the survey bot to undertake a survey in multiple languages.

It is an object of the present disclosure to provide a system to facilitate recording of videos in-line with the requirements of the survey and also facilitate the ability to map choice based questions to these relevant videos.

### SUMMARY

This section is provided to introduce certain objects and aspects of the present invention in a simplified form that are further described below in the detailed description. This summary is not intended to identify the key features or the scope of the claimed subject matter.

In an aspect, the present disclosure further provides for a system to generate a survey bot application specific to an entity. The system may include a processor that executes a set of executable instructions stored in a memory, the execution of which, the processor causes the system to receive, from a database, a knowledgebase that may include a set of survey queries associated with the entity, and receive one or more video frame responses corresponding to each query of the set of survey queries. The system may also cause the processor to extract a set of attributes pertaining to the set of survey queries, the set of attributes may be indicative of nature of the set of survey queries. Further, the processor may process, through a machine learning (ML) engine, training data that may include the set of attributes, the video frame responses corresponding to each of the survey query. The video frame responses may be selected and identified based on the extracted set of attributes. The one or more video frame responses may be mapped to each of the survey query of the set of survey queries to generate a trained model. Furthermore, the processor may determine, using the ML engine, an end survey result based on the mapped survey queries with the one or more video frame responses.

In another aspect, the present disclosure further provides for a method for facilitating survey of an entity through an executable survey bot. The method may include the steps of: receiving, from a database, a knowledgebase that may include a set of survey queries associated with said entity, and receiving one or more video frame responses corresponding to each query of the set of survey queries. The method may also include the step of extracting a set of attributes pertaining to the survey queries, said set of attributes may be indicative of natures of the set of survey queries and the step of processing, through a machine learning (ML) engine, training data that may include the set of attribute and the video frame responses corresponding to each survey query. The video frame responses may be selected and identified based on the extracted set of attributes, and the one or more video frame responses may be mapped to each survey query of the set of survey queries to generate a trained model. Further, the method may include the step of determining, using the ML engine, an end survey result based on the mapped survey queries with the one or more video frame responses.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings includes the invention of electrical components, electronic components or circuitry commonly used to implement such components.

FIG. 1 illustrates an exemplary network architecture in which or with which the system of the present disclosure can be implemented, in accordance with an embodiment of the present disclosure.

FIG. 2 illustrates an exemplary representation (200) of system (110) or a centralized server (112), in accordance with an embodiment of the present disclosure.

FIG. 3 illustrates exemplary method flow diagram (300) depicting a method for facilitating authorization on the bot application, in accordance with an embodiment of the present disclosure.

FIG. 4 illustrates an exemplary representation (400) of system architecture and its implementation, in accordance with an embodiment of the present disclosure.

FIGS. 5A and 5F illustrate exemplary interfaces of the bot, in accordance with an embodiment of the present disclosure.

The foregoing shall be more apparent from the following more detailed decription of the invention.

### DETAILED DESCRIPTION OF THE INVENTION

In the following description, for the purposes of explanation, various specific details are set forth in order to provide a thorough understanding of embodiments of the present disclosure. The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

The present invention provides a robust and effective solution to an entity or an organization by enabling them to implement a system for generating automatic visual responses without getting help from an expert/professional assistance as well as ability to customize responses for a set of survey queries. The set of survey queries may be any or a combination of open ended, ratings related, satisfaction related, choice related queries but not limited to these. The system may be configured to facilitate the set of queries to be linked to the video frame that have been recorded and also facilitate the user to initiate the survey at his/her convenience and resume the survey if there may be a break in the survey.

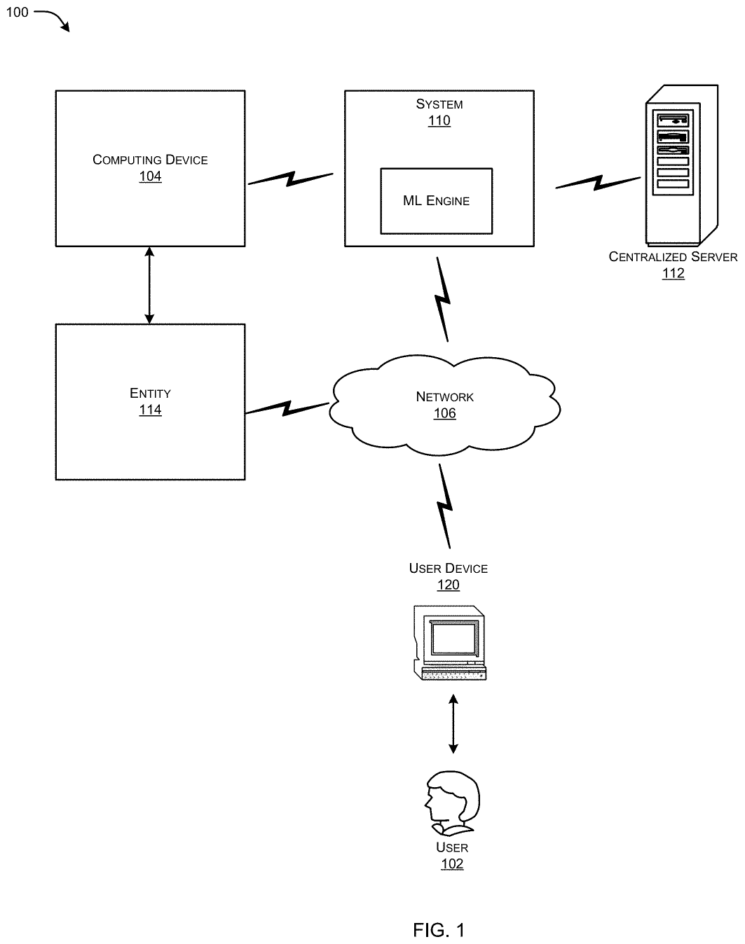

Referring to FIG. 1 that illustrates an exemplary network architecture (100) in which or with which system (110) of the present disclosure can be implemented, in accordance with an embodiment of the present disclosure. As illustrated in FIG. 1, by way of example and not by not limitation, the exemplary architecture (100) may include a user (102) associated with a user computing device (120) (also referred to as user device (120)), at least a network 106, at least a centralized server 110 and at least a second computing device (104) associated with an entity (114). More specifically, the exemplary architecture (100) includes a system (110) equipped with a machine learning (ML) engine (216) for facilitating conduction of a survey for the user (102) on the bot that can receive a first set of data packets that may include a video frame responses of a set of survey queries from the user computing device (120). The system (110) may include a database (210) that may store a knowledgebase having a set of survey queries associated with said entity (114) of the user (102) and a plurality of information services associated with the user (102) and the query generated by the user and the video frame responses corresponding to the set of survey queries. The user device (120) may be communicably coupled to the centralized server (110) through the network (106) to facilitate communication therewith. As an example and not by way of limitation, the computing device (104) may be operatively coupled to the centralised server (112) through the network (106) and may be associated with the entity (114) configured to generate the set of survey queries and record respective potential video frame responses of the set of queries.

In an embodiment, the system (110)/centralised server (112) may include attribute extraction engine (214). The attribute extraction engine (214) may be configured to extract a set of attributes pertaining to the set of survey queries. In an embodiment, the set of attributes may be indicative of nature of the set of survey queries. In another embodiment, the system (110)/server (112) may further configure the ML engine (216) to generate, through an appropriately selected machine learning (ML) model of the system in a way of example and not as limitation, a trained model configured to process, through a machine learning (ML) engine, training data that may include the set of attributes, the video frame responses corresponding to each survey query. The ML engine (216) may be configured to select and identify the video frame responses for each survey query based on the extracted set of attributes. The one or more video frame responses may be mapped to each survey query of the set of survey queries to generate a trained model. The ML engine further may determine an end survey result based on the mapped survey queries with the one or more video frame responses.

In an embodiment, the set of survey queries in the form of video frame responses may be initiated once an authorized user may generate a user query. The user query may be received at client side of the executable bot application in the form of a first set of data packets from a user computing device (120), and the video frame response corresponding to the set of survey queries may be transmitted in real-time in the form of a second set of data packets to the user computing device (120) from server side of the executable bot. In an embodiment, the user query may be in the form of any or a combination of textual, audio and video form, but not limited to it.

In an embodiment, the nature of the set of survey queries may correspond to any or a combination of open ended, ratings related, satisfaction related, choice related queries and the like but not limited to these.

In an embodiment, the client side of the executable bot may be represented in the form of any or a combination of an animated character, a personality character, or an actual representation of the entity character but not limited to it.

In yet another embodiment, the video frame responses may be manually recorded using a recording device associated with the computing device (104) of the entity (114) and the video responses may be arranged in sequential order based on the trained model. The recording device can be any or a combination of a camera, a video recorder and the like that may be either inbuilt or externally connected to the computing device (104) of the entity (102). The recording device may further include one or more audio recording accessories connected thereto. The entity may record the responsive video frames based on a list of pre-defined/potential set of survey queries and length of the recording can be reviewed and modified by the entity. The system (110) can enable the entity (114) to customize the pre-defined visual responses in a manner that may best suit the needs of the entity (114) for enhanced awareness of the operational services offered by them. In an embodiment, the pre-defined visual responses (input) and the automated visual responses (output) may include any or a combination of responsive video frames and visual display of information including, but not limited to, graphical data and images that may be informative with respect to the pre-defined query. In an exemplary embodiment, the responsive video frames may be video recording that may be manually recorded using a recording device coupled to a computing device of the entity. In an exemplary embodiment, if the entity is an organization, the responsive video frames may be recorded by one or more operators associated with the entity (114). Thus, using the implementation of the present disclosure, an entity can record videos anywhere and does not require the recording to be done in specific studios. In an exemplary embodiment, the computing device (104) may be communicably coupled via an interface of the system (110) such that the system (110) may receive the pre-defined video frame responses through an interface of the system (110).

In an embodiment, the user (102) may be identified, verified and then authorized to access the system. In an embodiment, the user may include, but not limited to, an existing customer, a potential customer, an interviewee, a research analyst, or any other person interested to take the survey offered by the entity. In an embodiment, an authoring portal module may be configured to create the set of survey queries in intuitive flow. In another embodiment, the authoring portal may be configured to create, update, delete any or a combination of the set of survey queries and video responses pertaining to the set of survey queries. In yet another embodiment, the authoring portal module may be configured to test the executable bot before generating the end survey result.

In an embodiment, the system is configured to resume an unfinished survey. In another embodiment, the set of survey queries may be any or a combination of open ended, ratings related, satisfaction related, choice related queries but not limited to these. In yet another embodiment, the system may be configured to facilitate the set of queries to be linked to the video frame that have been recorded and also facilitate the user to initiate the survey at his/her convenience and resume the survey if there may be a break in the survey.

In another embodiment, the ML engine may be configured with language processing engines to receive the user query in any language and provide the response corresponding to the user query in any language. In another embodiment, the user responses to the video responses of the set of survey queries may be stored in any or a combination of textual, audio and video form. In yet another embodiment, the user responses may be stored in the database coupled to the centralised server (112).

In an embodiment, the end survey result may be displayed in a dashboard coupled to an authoring portal module associated with the ML engine. In yet another embodiment, the responses to the set of survey queries may be stored in a cloud.

In an embodiment, the computing device (104) and/or the user device (120) may communicate with the system (110) via set of executable instructions residing on any operating system, including but not limited to, Android™, iOS™, Kai OS™ and the like. In an embodiment, computing device (104) and/or the user device (120) may include, but not limited to, any electrical, electronic, electro-mechanical or an equipment or a combination of one or more of the above devices such as mobile phone, smartphone, virtual reality (VR) devices, augmented reality (AR) devices, laptop, a general-purpose computer, desktop, personal digital assistant, tablet computer, mainframe computer, or any other computing device, wherein the computing device may include one or more in-built or externally coupled accessories including, but not limited to, a visual aid device such as camera, audio aid, a microphone, a keyboard, input devices for receiving input from a user such as touch pad, touch enabled screen, electronic pen and the like. It may be appreciated that the computing device (104) and/or the user device (120) may not be restricted to the mentioned devices and various other devices may be used. A smart computing device may be one of the appropriate systems for storing data and other private/sensitive information.

In an exemplary embodiment, a network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. A network may include, by way of example but not limitation, one or more of: a wireless network, a wired network, an internet, an intranet, a public network, a private network, a packet-switched network, a circuit-switched network, an ad hoc network, an infrastructure network, a public-switched telephone network (PSTN), a cable network, a cellular network, a satellite network, a fiber optic network, some combination thereof.

In another exemplary embodiment, the centralized server (112) may include or comprise, by way of example but not limitation, one or more of: a stand-alone server, a server blade, a server rack, a bank of servers, a server farm, hardware supporting a part of a cloud service or system, a home server, hardware running a virtualized server, one or more processors executing code to function as a server, one or more machines performing server-side functionality as described herein, at least a portion of any of the above, some combination thereof.

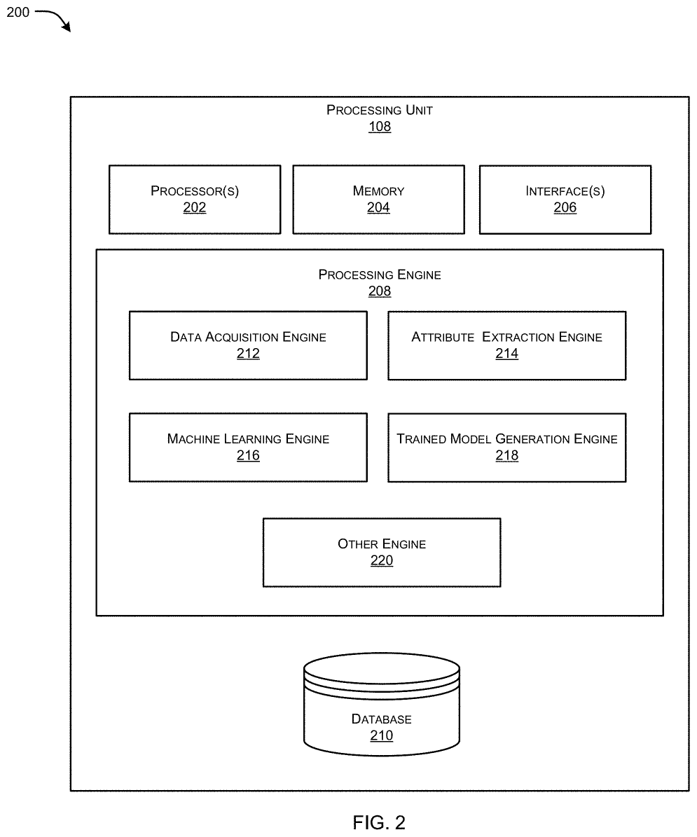

In an embodiment, the system (110) may include one or more processors coupled with a memory, wherein the memory may store instructions which when executed by the one or more processors may cause the system to perform the generation of automated visual responses to a query. FIG. 2 with reference to FIG. 1, illustrates an exemplary representation of system (110)/centralized server (112) for facilitating survey of an entity on the bot through which one or more automated visual responses to a user query may be transmitted based on a machine learning based architecture, in accordance with an embodiment of the present disclosure. In an aspect, the system (110)/centralized server (112) may comprise one or more processor(s) (202). The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (206) of the system (110). The memory (206) may be configured to store one or more computer-readable instructions or routines in a non-transitory computer readable storage medium, which may be fetched and executed to create or share data packets over a network service. The memory (206) may comprise any non-transitory storage device including, for example, volatile memory such as RAM, or non-volatile memory such as EPROM, flash memory, and the like.

In an embodiment, the system (110)/centralized server (112) may include an interface(s) 204. The interface(s) 204 may comprise a variety of interfaces, for example, interfaces for data input and output devices, referred to as I/O devices, storage devices, and the like. The interface(s) 204 may facilitate communication of the system (110). The interface(s) 204 may also provide a communication pathway for one or more components of the system (110) or the centralized server (112). Examples of such components include, but are not limited to, processing engine(s) 208 and a database 210.

The processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110)/centralized server (112) may comprise the machine-readable storage medium storing the instructions and the processing resource to execute the instructions, or the machine-readable storage medium may be separate but accessible to the system (110)/centralized server (112) and the processing resource. In other examples, the processing engine(s) (208) may be implemented by electronic circuitry.

The processing engine (208) of the survey bot engine may include one or more engines selected from any of a data acquisition engine (212), an attribute extraction (214) engine, a machine learning (ML) engine (216), and other engines (218). In an embodiment, the data acquisition engine (212) of the system (110) can receive/process/pre-process a video frame corresponding to the set of survey queries. The video frame may be first acquired by the data acquisition engine by recording the required video through a recording device coupled to the computing device (104) associated with the entity (114). The video frame responses can be recorded for each set of survey queries acquired by the data acquisition engine (212) from a database (210) having a knowledgebase that may include a set of survey queries associated with the entity (114). In an embodiment, the video frame responses can be submitted or deleted or uploaded from third party sources. Thus, the data acquisition engine (212) can receive pre-defined visual responses in the form of video frame responses from the computing device (104) through an interface of the system and store them in a database (210) based on prestored parameters associated with each pre-defined survey query among the set of survey queries.

In an embodiment, the proposed system may include an attribute extraction engine (214) configured to extract a set of attributes pertaining to the set of survey queries. The set of attributes may be associated with the video frame responses indicative of which video frame can correspond to which survey query of the set of survey queries to the user for facilitating the survey.

In an aspect, the ML engine (216) can be configured to process, through a machine learning (ML) model of the system, training data that may include the extracted set of attributes, the video frame responses corresponding to each survey query. In an embodiment, the video frame responses may be selected and identified based on the extracted set of attributes. In yet another embodiment, the video frame responses may be mapped to each survey query of the set of survey queries based on the extracted set of attributes to generate a trained model by the trained model generation engine (218). In yet another aspect, the ML engine (216) may be configured to generate an end survey result based on the mapped set of survey queries with the video frame responses and the trained model generated by the trained model generation engine (218).

In an embodiment, the ML engine (216) along with the trained model generation engine (218) may be configured to select and identify type of survey query that is to be displayed along with the specific video frame response to be played for that survey query. In another embodiment, the ML engine (216) along with the trained model generation engine (218) may also be configured to customize the survey query selected within the survey query type selected. As the bot may be focused towards conducting a video survey, the ability of the bot to handle different type of queries may be an integral aspect for the success of such a bot. Predominantly, the nature of questions may be of the following types: single selection questions, multiple selection questions, ranking questions with established tags, rating questions with options, questions using scaling, open ended questions, ranking based questions, quantitative questions and the like. Each query type may entail asking the user a type of query appropriate for that survey: For example, a single selection question type may be customized and another question may be customized to provide an open-ended response.

In an exemplary embodiment, the ML engine (216) and the trained model generated can enable linking of recorded video frame responses to the survey question finalised. All video frame responses duly recorded must have their relevant customized survey queries duly linked to the video frame responses. This may be done so that the recorded video frame responses and the customized survey query to be display may be synchronized to convey the correct survey query to the user for answering. The final bot may therefore show the respondent the mapped survey query for the video frame response that may be recorded so that the survey can be conducted.

In yet another exemplary embodiment, the survey queries can be then organised in a sequence in which the video frame responses and the survey queries can be played within the interface of the survey bot engine once the user initiates the survey bot engine in order to ensure that the survey may follow a pre-defined structure. In an example and not as a limitation, video frame responses that are recorded may be initiated with a Greeting video to the user (102). Thereon, the user could be urged to start with a series of survey queries that are to be answered in the pre-defined sequence.

In an aspect, the user query can be received at client side of the executable bot application in the form of a first set of data packets from an user computing device, and wherein the video frame response can be transmitted in real-time in the form of a second set of data packets to the user computing device from server side of the executable bot application. In another aspect, the client side of the executable bot application can be represented in the form of any or a combination of an animated character, a personality character, or an actual representation of the entity character but not limited to the like.

In an exemplary embodiment, the set of survey queries can be by a way of example and not as limitation single selection questions, multiple selection questions, ranking questions with established tags, rating questions with options, questions using scaling, open ended questions, ranking based questions, quantitative questions and the like.

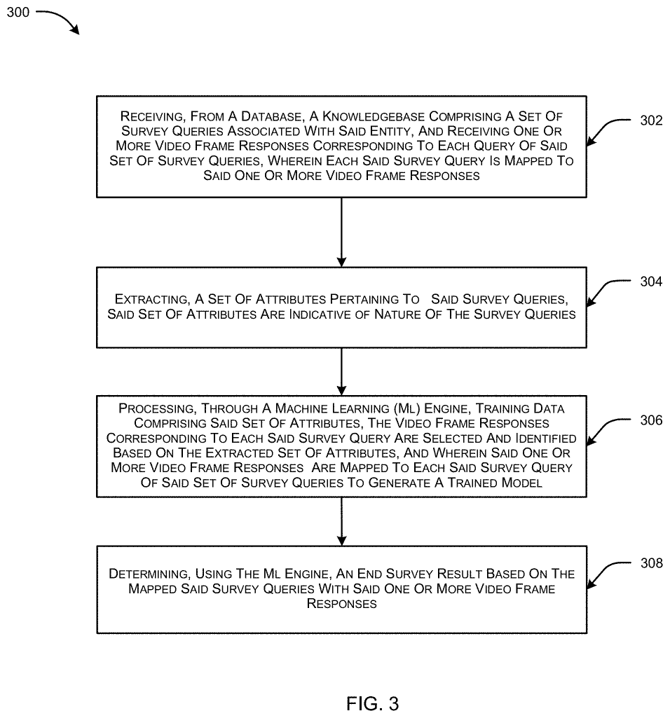

FIG. 3 illustrates exemplary method flow diagram (300) depicting a method for facilitating authorization on the bot application, in accordance with an embodiment of the present disclosure.

As illustrated, in an aspect the method may facilitate survey of an entity on the bot through a series of steps. The method may include at 302, the step for receiving, from a database, a knowledgebase that may include a set of survey queries associated with said entity, and receiving one or more video frame responses corresponding to each query of the set of survey queries. The method may also include at 304, the step of extracting a set of attributes pertaining to the survey queries, said set of attributes are associated with said video frame responses to the user for facilitating the survey and at 306, the step of processing, through a machine learning (ML) engine, training data that may include the set of attribute and the video frame responses corresponding to each survey query. The video frame responses may be selected and identified based on the extracted set of attributes, and the one or more video frame responses may be mapped to each survey query of the set of survey queries to generate a trained model.

Furthermore, the method may include at 308, the step of determining, using the ML engine, an end survey result based on the mapped survey queries with the one or more video frame responses.

In an exemplary embodiment, the method may include the step of recording the video responses through a recording device coupled to the computing device associated with the entity. In another embodiment, the survey query may be customized and selected within the survey query type selected. In another exemplary embodiment, recorded video frame responses can be linked to the survey query finalised. In yet another exemplary embodiment, the survey queries can be then organised in a sequence in which the video frame responses and the survey queries can be played within the interface of the survey bot engine in order to ensure that the survey may follow a pre-defined structure once the user initiates the survey bot.

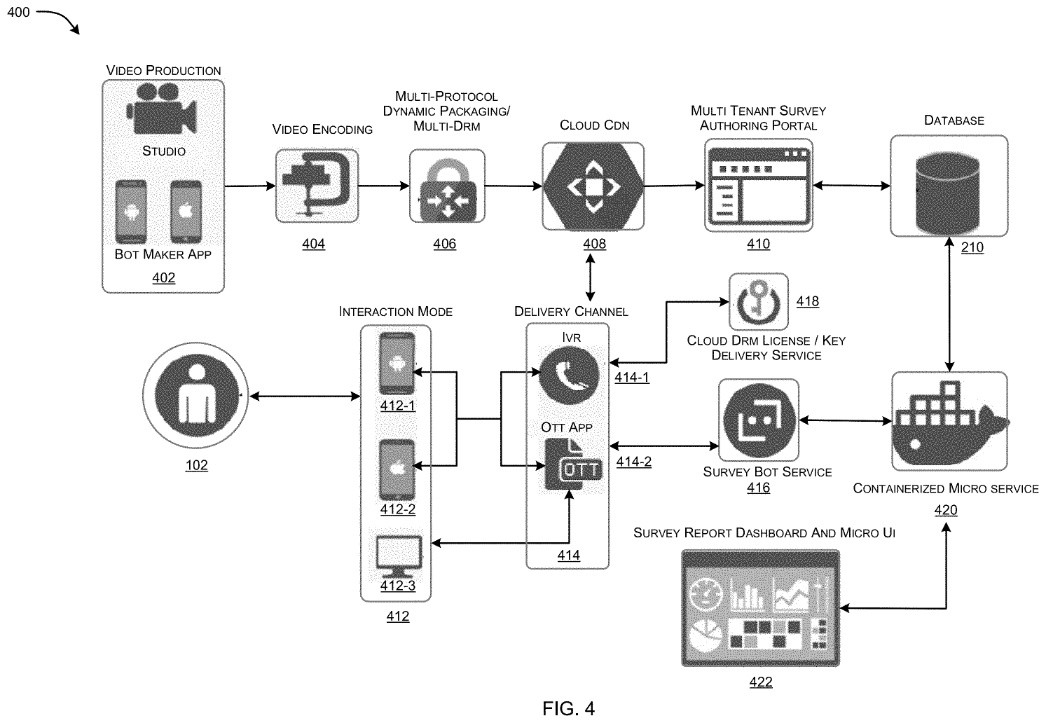

FIG. 4 illustrates an exemplary representation (400) of system architecture and its implementation, in accordance with an embodiment of the present disclosure.

As illustrated, the system architecture as a way of example and not as a limitation, may include the video recording module (402) for the survey bot which may record video frame responses through studios or through Bot maker engine. The video frame responses may be then encoded and segmented to make them ready for adaptive delivery by the video encoding module (404). The video frame responses may be DRM protected to prevent unauthorized access by the Multi-protocol Dynamic packaging multi DRM (406). The video frame responses can be then hosted on cloud CDN (408) to provide high availability and reduce latency with adaptive media delivery capability. Multi-Tenant Survey Bot Authoring Portal (410) (also referred to as Portal (410) hereinafter) may be then configured to generate the set of survey queries. In an embodiment, the portal (410) may have capability of creating surveys in an intuitive wizard flow. In another embodiment, the portal (410) as a way of example and not as a limitation may have capability to create, update, delete any of the survey generated and the set of survey queries generated for the survey. In yet another embodiment, the portal (410) may have capability to test the bot before publishing. The surveys, the set of survey queries, the video frame responses for the set of survey queries may be stored in database (210). In an embodiment, a containerized microservice (420) may highlight published surveys to a authorized user.

In an aspect, the survey can be taken through a plurality of interaction modes (412) and a plurality of delivery channels (414). In an exemplary embodiment, by way of an example and not as a limitation, a user (102) can take the survey by dialling a number on mobile, making an IP call, through video survey bot embedded in the user/customer portal but not limited to it. Auto diallers can also be used to connect survey bots to the user (102). In another exemplary embodiment, the delivery channel (414) for delivering the survey can be through IVR, OTT and the like but not limited to it. After initial authentication and authorization the survey will start. The set of survey queries and other information can be fetched through survey microservice (416). The DRM protected video frame responses and related content for the bot can be accessed through CDN network but not limited to it after acquiring the DRM license key 418 from the server. The user can have capability of resuming an unfinished survey. Once the user completes the survey, the end survey result and survey data can be uploaded on the cloud 418 but not limited to it through microservice (416). The end survey result can be available on a Dashboard and Reporting Micro UI (422) and can be embedded in the portal (410).

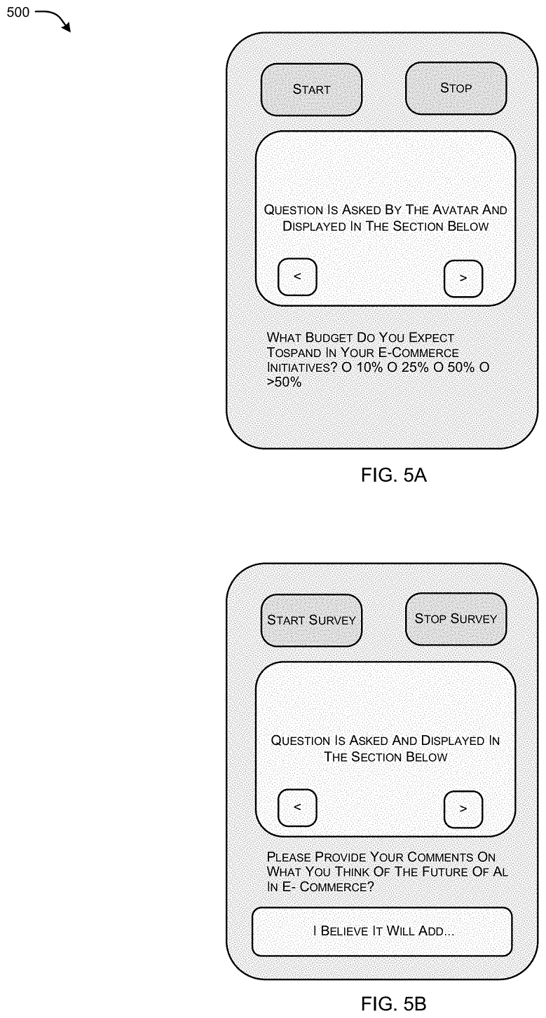

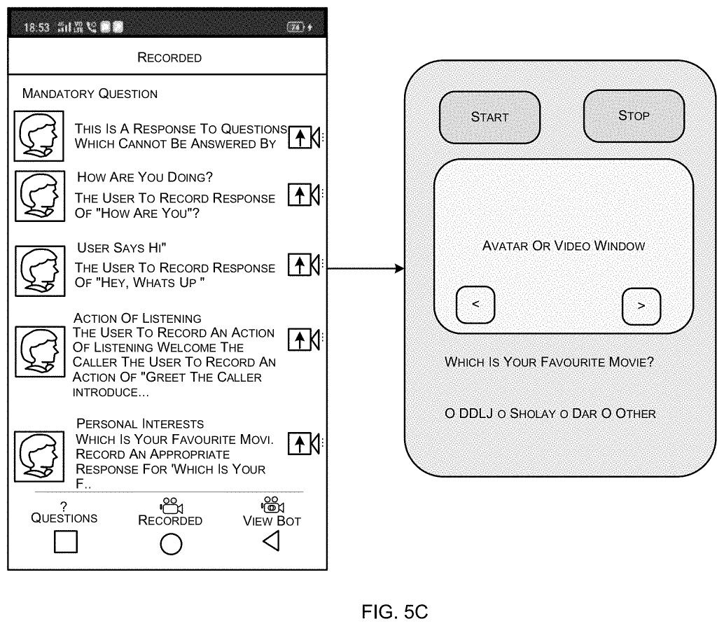

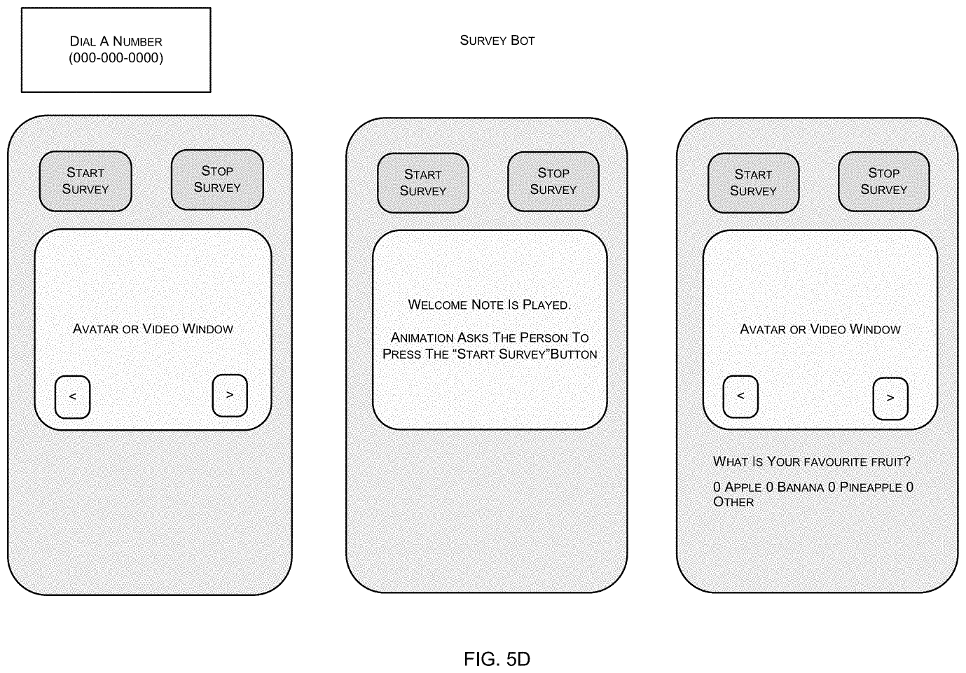

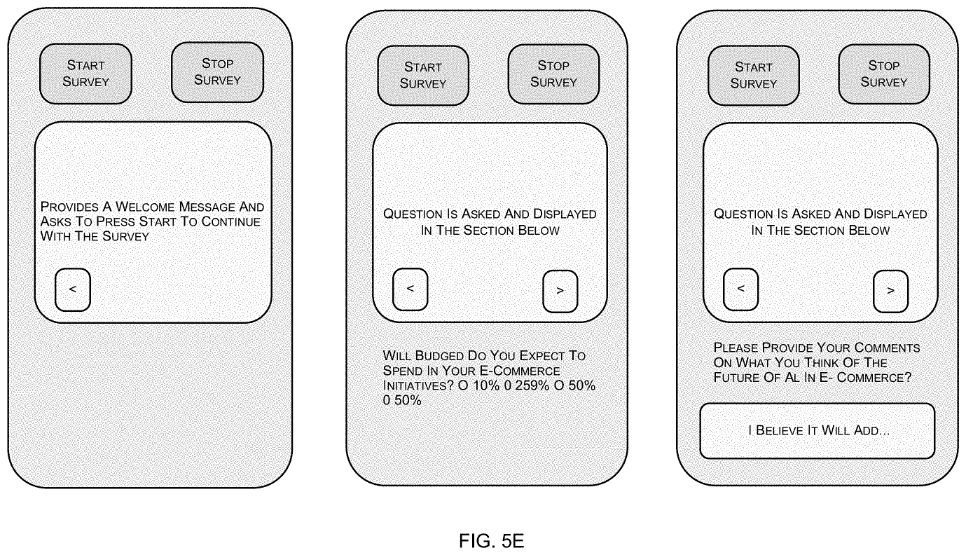

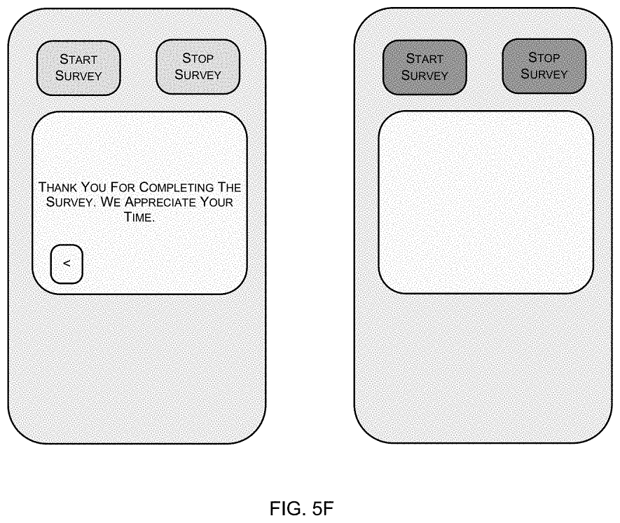

FIGS. 5A and 5E illustrate exemplary interfaces of the bot, in accordance with an embodiment of the present disclosure.

As illustrated, in FIG. 5A-5C, as an example but not as a limitation, the video interviewing bot initiates the video frame responses and the corresponding survey queries. FIG. 5D shows that the user will be asked to call a number or click a link which will allow the video to be activated on his/her device and FIG. 5E shows that an Avatar will play a welcome video for the user. The Avatar will further ask the user to initiate the survey by clicking the “Start Survey” Button as illustrated in FIG. 5E. Once the button is pressed by the user, the first and subsequent questions along with the relevant video frame responses are played to the user. The user makes the selection on the screen pertaining to the survey query asked by the Avatar as depicted in FIG. 5E. On completion of the survey, the Avatar plays a “Thank you” video to the respondent indicating that the survey has been completed as illustrated in FIG. 5F. FIG. 5F also depicts that the system disables the “Start Survey” and “Stop Survey” button and ends the survey on completion of all survey queries.

In an exemplary embodiment, the stored user responses can now be utilized for analysis by the entity conducting the survey.

Thus, the present disclosure provides a unique and inventive solution for facilitating generation of one or more automated visual responses for a survey based on a machine learning based architecture, thus providing an automated and improved user experience solution. The solution offered by the present disclosure ensures that the response generation is accurate/precise due to the involvement of well-trained ML engine. Further, other benefits include quick go-to-market strategy for those entity/organizations that do not wish to expend excessive time in developing and managing the technology as the system of the present disclosure is a ready to implement solution with no special training in ML and without need for a professional expert/knowledge. The present disclosure can lead to huge cost savings by way of studio costs in recording queries and responses, otherwise required conventionally. Further, the recording of the videos can be done at leisure and using a background that is most appropriate for the promotion activity. It is important to realize that the system is easy to use, has ability to re-record videos should there be a change in the content requirement, ability to record with different models/speakers, ability to support multiple languages, is highly scalable, allowing the users to enhance the scope of coverage, if needed. Furthermore, the bot can provide a more personal front and replace phone based interviews with video based ones, remove the need to train a large number of people for undertaking survey and related research. The present disclosure can also lead to quick and accurate capturing of information thereby minimizing mistakes and eliminate human errors, human bias from the survey process and can ensure the completion of the survey at a time convenient to the user taking the survey, terminate the survey at his/her discretion and also resume the survey if there is a break while taking the survey. The technical advantages of the present disclosure also includes an ability of the technology to cater to all languages, easy-to-use Interface, the system caters to both Android, Kai OS and IOS and the like, scalability of the technology allows the customers to enhance the scope of coverage needed to promote additional services and products, the ability of the bot to play Video, Voice and Text equally well in Traditional Telephony Networks (1800s) and OTT web environment (Apps, Websites) via OTT SDK and thus allow the digital imprint of these technologies to foray across the gamut of industries.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

### Advantages of the Present Disclosure

The present disclosure provides a number of advantages over existing technologies.

The present disclosure provides for a system and method to enable an entity-specific bot for conducting surveys.

The present disclosure provides for a system to facilitate a more personal front to surveys and replace audio and chat based platforms with a more personalized video based service.

The present disclosure provides for a system and method for enabling removing the need to train a large number of people for asking survey queries to respondents.

The present disclosure provides for a system and method for enabling an entity to implement as well as customize visual responses that are generated to an user query based on their requirements, without the need to hire an expert/professional assistance.

The present disclosure provides for a system and method that can provide a platform to an user for getting, from an entity-specific bot, automated visual/video frame responses to a query regarding one or more operational services provided by an entity.

The present disclosure provides for a system and method to facilitate quick and accurate capture of responses by the survey bot thereby minimizing mistakes

The present disclosure provides for an approach for removing human bias from an interview process especially where likeability, satisfaction or rating scales are involved.

The present disclosure provides for a system and method for ensuring that users taking the survey are able to complete the survey at a time convenient to them and terminate the survey at their discretion.

The present disclosure provides for a system and method to facilitate the survey bot to undertake a survey in multiple languages.

The present disclosure provides for a system and method to facilitate recording of videos in-line with the requirements of the survey and also facilitate the ability to map choice based questions to these relevant videos.

The present disclosure provides for a system and method that allows the video recording service to be made available to the entity conducting surveys.

The present disclosure provides for a system and method that facilitates a novel way of making surveys cost effectively by eliminating the need to hire experience market research personnel in undertaking the same

The present disclosure provides for a system and method that allows a survey to be exposed to a large and predetermined list of respondents thereby saving time of the surveying organization.

The present disclosure provides for a system and method that facilitates service to be undertaken on a mobile computing device without the need to download an application.

We claim:

1. A system for facilitating survey of an entity through an executable survey bot, said system comprising a processor that executes a set of executable instructions stored in a memory, upon execution of which, the processor causes the system to:
receive, from a database, a knowledgebase comprising a set of survey queries associated with said entity, and receive one or more video frame responses corresponding to each survey query of said set of survey queries;
extract, a set of attributes pertaining to said survey queries, said set of attributes are indicative of nature of the set of survey queries;
process, through a machine learning (ML) engine, training data comprising said set of attributes, the one or more video frame responses corresponding to each said survey query, wherein said one or more video frame responses are selected and identified based on the extracted set of attributes, and wherein said one or more video frame responses are mapped to each said survey query of said set of survey queries based on the extracted set of attributes to generate a trained model; and
determine, using the ML engine, an end survey result based on the mapped said survey queries with said one or more video frame responses.

2. The system as claimed in claim 1, wherein said set of survey queries in the form of video frame responses are initiated once an authorized user query generates a user query, wherein said user query is received at client side of the executable bot application in the form of a first set of data packets from a user computing device, and wherein the video frame response corresponding to said set of survey queries is transmitted in real-time in the form of a second set of data packets to said user computing device from server side of the executable bot.

3. The system as claimed in claim 1, wherein the nature of the set of survey queries corresponds to any or a combination of open ended, ratings related, satisfaction related, choice related queries

4. The system as claimed in claim 1, wherein said user query is in the form of any or a combination of textual, audio and video form.

5. The system as claimed in claim 1, wherein said client side of the executable bot is represented in the form of any or a combination of an animated character, a personality character, or an actual representation of the entity character.

6. The system as claimed in claim 1, wherein said video frame responses are manually recorded using a recording device, wherein said video responses are arranged in sequential order based on the trained model.

7. The system as claimed in claim 1, wherein a user is identified, verified and then authorized to access the system.

8. The system as claimed in claim 1, wherein an authoring portal module is configured to create said set of survey queries in intuitive flow, wherein the authoring portal module is configured to create, update, delete any or a combination of said set of survey queries and video responses pertaining to said set of survey queries and wherein the authoring portal module is configured to test the executable bot before generating said end survey result.

9. The system as claimed in claim 1, wherein the system is configured to resume an unfinished survey.

10. The system as claimed in claim 1, wherein the ML engine is configured with language processing engines to receive said user query in any language and provide said response corresponding to said user query in any language.

11. The system as claimed in claim 1, wherein user responses to said video responses of said set of survey queries is stored in any or a combination of textual, audio and video form, wherein said user responses are stored in the database coupled to said server.

12. The system as claimed in claim 1, wherein said end survey result is displayed in a dashboard coupled to an authoring portal module associated with the ML engine.

13. The system as claimed in claim 1, wherein said responses to said set of survey queries are stored in a cloud.

14. A method for facilitating survey of an entity through an executable survey bot, said method comprising:
receiving, from a database, a knowledgebase comprising a set of survey queries associated with said entity, and receiving one or more video frame responses corresponding to each survey query of said set of survey queries;
extracting, a set of attributes pertaining to said survey queries, said set of attributes are indicative of nature of the survey queries;
processing, through a machine learning (ML) engine, training data comprising said set of attributes, the video frame responses corresponding to each survey query, wherein said one or more video frame responses are selected and identified based on the extracted set of attributes, and wherein said one or more video frame responses are mapped to each said survey query of said set of survey queries based on the extracted set of attributes to generate a trained model; and
determining, using the ML engine, an end survey result based on the mapped said survey queries with said one or more video frame responses.

15. The method as claimed in claim 14, wherein said set of survey queries in the form of video responses are initiated once an authorized user query generates a user query, wherein said user query is received at client side of the executable bot in the form of a first set of data packets from a user computing device, and wherein the video frame response corresponding to said set of survey queries is transmitted in real-time in the form of a second set of data packets to said user computing device from server side of the executable bot.

16. The method as claimed in claim 14, wherein said user query is in the form of any or a combination of textual, audio and video form.

17. The method as claimed in claim 14, wherein said client side of the executable bot is represented in the form of any or a combination of an animated character, a personality character, or an actual representation of the entity character.

18. The method as claimed in claim 14, wherein said video frame responses are manually recorded using a recording device, wherein said video responses are arranged in sequential order based on the trained model.

19. The method as claimed in claim 14, wherein a user is identified, verified and then authorized to access the method.

20. The method as claimed in claim 14, wherein an authoring portal module is configured to create said set of survey queries in intuitive flow, wherein the authoring portal module is configured to create, update, delete any or a combination of said set of survey queries and video responses pertaining to said set of survey queries and wherein the authoring portal module is configured to test the executable bot before generating said end survey result.

21. The method as claimed in claim 14, wherein the method is configured to resume an unfinished set of survey queries.

22. The method as claimed in claim 14, wherein the ML engine is configured with language processing engines to receive said user query in any language and provide said user response corresponding to said user query in any language.

23. The method as claimed in claim 14, wherein user responses to said video responses of said set of survey queries is stored in any or a combination of textual, audio and video form, wherein said user responses are stored in a database.

24. The method as claimed in claim 14, wherein said end survey result is displayed in a dashboard coupled to an authoring portal module associated with the ML engine.

25. The method as claimed in claim 14, wherein said responses to said set of survey queries are stored in a cloud.
